(19) United States
(12) Patent Application Publication
(10) Pub. No.: US 2007/0055752 A1
(43) Pub. Date: Mar. 8, 2007

(54) Dynamic network connection based on compliance

(75) Inventors: Jim Wiegand, Philadelphia, PA (US); Michael Sinz, Elverson, PA (US)

Correspondence Address: JLB CONSULTING, INC.;c/o INTELLEVATE, P.O. BOX 52050, MINNEAPOLIS, MN, 55402, US

(73) Assignee: Fiberlink

(21) Appl. No.: 11/221,567

(22) Filed: Sep. 8, 2005

(51) Int. Cl. G06F 15/177

(52) U.S. Cl. 709/220

(57) ABSTRACT

Disclosed herein are systems and methods to dynamically connect a communication device to the appropriate computer network according to the compliance level of the communication device. In one embodiment, a communication device connected to a compliance network is checked for sufficient compliance with one or more policies of a destination network. If not in sufficient compliance, the communication device in this embodiment is not allowed while insufficiently compliant to connect to the destination network, and optionally receives any appropriate updates via the connection with the compliance network. If in sufficient compliance or when rendered in sufficient compliance, the communication device is allowed in this embodiment to connect to the destination network via a connection that is not identical to the connection previously established between the communication device and the compliance network. Disclosed herein in another aspect of the invention are systems and methods to transfer, within an authentication protocol conversation, data which is unrelated to the authentication protocol.

### FIELD OF THE INVENTION

The invention relates generally to computer networks and more specifically to compliance checking and remediation for communication devices connecting to computer networks.

### BACKGROUND OF THE INVENTION

A communication device accessing a computer network should conform to the policies which are set for that computer network. In many cases some or all of the policies may be updated from time to time and therefore the communication device may also be required to be updated in order to access the computer network.

In the related art, when a communication device connects to a computer network, a gateway to the computer network checks the communication device for compliance with the policies of the network, and if necessary remedies any areas of non-compliance. Once the communication device has received any necessary compliance remediation, the communication device is allowed to “enter” the network, i.e. to access other nodes on the computer network. Typically in this related art the received compliance remediation is applied to the communication device only after the communication device disconnects from the computer network.

### SUMMARY OF THE INVENTION

According to the present invention, there is provided a system for enabling compliance of a communication device with the policies of a destination network, comprising: a communication device configured to connect to a compliance network; the compliance network configured to check whether the communication device is sufficiently in compliance with at least one predetermined policy of a destination network and to not allow the communication device to connect with the destination network if the communication device is not sufficiently in compliance with the at least one predetermined policy; and a connection including a first configuration to connect between the compliance network and the communication device, and a second configuration varying at least partially from the first configuration to connect between the communication device and the destination network.

According to the present invention, there is also provided a communication device, comprising: means for selecting a connection between the communication device and a destination network or between the communication device and a compliance network exclusive of the destination network; and means for establishing the selected connection; wherein the means for selecting is configured to select the connection with the compliance network exclusive of the destination network when a likelihood that the communication device is not in sufficient compliance with at least one predetermined policy of the destination network exceeds a predetermined level.

According to the present invention, there is further provided a method of enabling compliance of a communication device with the policies of a destination network, comprising: operating a communication device intending to connect to a destination network via a connection between the communication device and the destination network, the communication device connecting instead to a compliance network via a connection between the communication device and the compliance network, wherein the connection between the communication device and the destination network is different than the connection between the communication device and the compliance network; checking, by the compliance network, the communication device for sufficient compliance with at least one predetermined policy of the destination network; and preventing, if the communication device is not in sufficient compliance with the at least one predetermined policy, the communication device from connecting to the destination network.

According to the present invention, there is still further provided a method for transferring data between a communication device and a computer network, comprising: transferring data between the communication device and the computer network within an authentication protocol conversation between an AAA server and client thereof, wherein the data includes data unrelated to the authentication protocol.

According to the present invention, there is yet further provided a system for transferring data between a communication device and a computer network, comprising: a communication device and a computer network; and an AAA server and a client to the AAA server connected between the communication device and the computer network; wherein an authentication protocol conversation between the server and the client is used to transfer data between the communication device and the computer network, the data including data unrelated to the authentication protocol.

### BRIEF DESCRIPTION OF THE DRAWING FIGURES

The invention is herein described, by way of example only, with reference to the accompanying drawings, wherein:

FIG. 1 is a block diagram of a configuration for dynamic network connection based on compliance, according to an embodiment of the present invention;

FIG. 2 is a flowchart of a method for dynamic network connection based on compliance, according to an embodiment of the present invention;

FIG. 3 is a block diagram illustrating the modules of the communication device and compliance network in the configuration of FIG. 1, according to an embodiment of the present invention;

FIG. 4 is a block diagram illustrating the connection between the communication device and the destination network and the connection between the communication device and the compliance network in the configuration of FIG. 1, according to an embodiment of the present invention;

FIG. 5 is a block diagram illustrating an example of the connections of FIG. 4, according to an embodiment of the present invention;

FIG. 6 is a block diagram illustrating the connection between the communication device and the destination network and the connection between the communication device and the compliance network in the configuration of FIG. 1, according to another embodiment of the present invention;

FIG. 7 is a block diagram illustrating an example of the connections of FIG. 6, according to an embodiment of the present invention;

FIG. 8 is a is a block diagram of a configuration for transferring data in an authentication protocol conversation, according to an embodiment of the present invention; and

FIG. 9 is a flowchart of a method for transferring data in an authentication protocol conversation, according to an embodiment of the present invention.

### DETAILED DESCRIPTION OF THE INVENTION

Described herein are embodiments of the current invention including methods and systems for dynamic network connection based on compliance.

The principles and operation of dynamic network connection based on compliance according to the present invention may be better understood with reference to the drawings and the accompanying description. All examples given below are non-limiting illustrations of the invention described and defined herein.

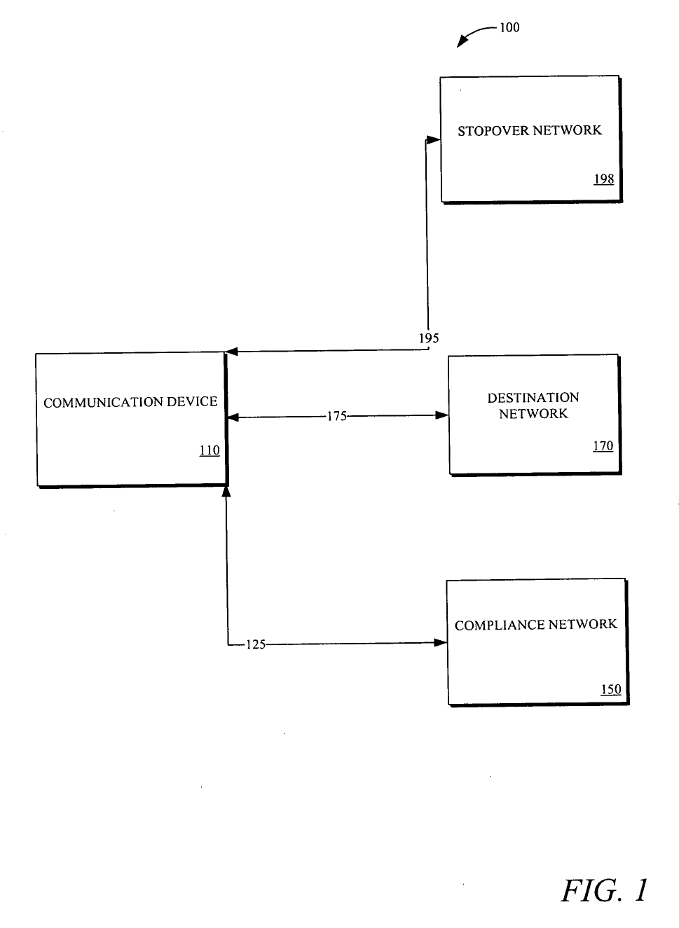

FIG. 1 is a block diagram of a configuration 100 for dynamic network connection based on compliance, according to an embodiment of the present invention. Configuration 100 includes one or more communication devices 110, one or more compliance networks 150, one or more destination networks 170, and optionally one or more stopover networks 198. Configuration 100 also includes one or more device-compliance connections 125 connecting between communication device(s) 110 and compliance network(s) 150, one or more device-destination connection(s) 175 connecting between communication device(s) 110 and destination network(s) 170, and optionally one or more device-stopover connection(s) 195 connecting between communication device(s) 110 and stopover network(s) 198. For ease of description, it is assumed that there is one compliance network 150, but it should be evident to the reader that in alternative embodiments there may be more than one compliance networks, for example sharing configuration and remediation information, and that similar methods and systems to those described below can be used in those alternative embodiments, mutatis mutandis. For ease of description it is also assumed that one destination network 170, one device-compliance connection 125, one device-destination connection 175, optionally one stopover network 198, and optionally one device-stopover connection 195 are associated with a particular compliance network 150, but it should be evident to the reader that in alternative embodiments a particular compliance network 150 may be associated with a plurality of destination networks 170, a plurality of device-compliance connections 125, a plurality of device-destination connections 175, a plurality of device-stopover connections 195, and/or a plurality of stopover networks 198 and that similar methods and systems to those described below can be used in those alternative embodiments mutatis mutandis.

For ease of illustration, only one communication device 110 is illustrated in FIG. 1, although as mentioned above, one or more communication devices 110 may participate in configuration 100. Communication device 110 may be any combination of software, hardware and/or firmware that is configured to perform the functions as defined and explained herein, including connecting to destination network 170 when appropriate. Examples of communication devices 110 include inter-alia cellular phones, pagers, fax machines, telephones, desktop computers, laptop computers, other types of computers, personal digital assistants PDAs, etc. as appropriate to the applicable destination network 170.

Destination network 170 can be any computer network which communication device 110 desires to access, for example the Internet, a local area network LAN such as a corporate LAN, a wide area network WAN, a campus area network CAN, a metropolitan area network MAN, a home area network HAN, a virtual private network VPN, a personal area network PAN, a corporate or demilitarized zone network DMZ, etc. The term computer network as used here and below includes embodiments where the network comprises one computer (programmable machine) and embodiments where the network comprises a plurality of computers (programmable machines) linked together.

Associated with destination computer network 170 are one or more policies specifying desirable or required attributes for any communication device 110 accessing destination network 170. Examples of policies include one or more of the following inter-alia: software configuration(s), connectivity policy configuration(s), user interface policy(ies), security configuration(s), third party software policy(ies), generic file download(s), and cryptographic key(s). Application of up-to-date associated polic(ies) prepares communication device 110 for properly accessing destination communication network 170. Depending on the desired level of security, security policies and compliance requirements may be set and/or enforced by one or more different parties in the various manners described herein. Typically, security policies and compliance enforcement set and performed by a server such as destination network 170 are more secure than policies and enforcement done by a client such as communication device 110 or other party.

Compliance network 150 can be any computer network which includes any combination of software, hardware and/or firmware that performs the functions as defined and explained herein. Compliance network 150 is configured to check the compliance of communication device 110 vis-à-vis the up-to-date policies of destination network 170, and to remedy non-compliance. Depending on the embodiment compliance network 150 may be concentrated in one location or parts of compliance network 150 may be distributed over more than one location.

Stopover network 198 can be any suitable computer network to which communication device 110 connects under some circumstances instead of to destination network 170, after having been connected to compliance network 150, as will be explained further below.

Connections 125, 175 and 195 can be any connections suitable for connecting the applicable parts of configuration 100. Depending on the embodiment there may or may not be some sharing of elements among two or more of connections 125, 175, and 195. Depending on the embodiment, any of connections 125, 175 and 195 may or may not require one or more of the following, inter-alia: exclusion of access to other networks (for example not allowing split tunneling in the case of a VPN), integrity of data transport (for example using transmission control protocol TCP or other transport protocols and/or with message digest in the case of Internet Protocol security IPsec), validation of destination (for example using client certificates, pre-shared secrets, and/or mutual authentication via cryptographic methods such as Diffie-Hellman), and data security (for example by direct connection over a switched network and/or by encryption of a VPN tunnel).

As will be apparent to the reader from the description herein, communication device 110 dynamically connects to compliance network 150, destination network 170, or stopover network 198 based on one or more conditions related to the compliance of communication device 110. Communication device 110 connects to compliance network 150 without also being connected to destination network 170 (i.e. establishes a connection with compliance network 150 which is exclusive of destination network 170) when the likelihood that communication device 110 is not sufficiently in compliance with at least one policy of destination network 170 is above a predetermined level. Depending on the embodiment, the predetermined level may vary, with some embodiments necessitating a connection with compliance network 150 exclusive of destination network 170 even if there is a slight likelihood of insufficient compliance whereas other embodiments necessitate a connection with compliance network 150 exclusive of destination network 170 only if there is a substantial likelihood of insufficient compliance. Conversely, depending on the embodiment, a connection with destination network 170 may be allowed if the likelihood that communication device 110 is sufficiently compliant with all policies of destination network 170 is above a predetermined level, where the predetermined level can in some cases require perfect certainty and in other cases require less than perfect certainty. For example, when there exists at least a predetermined level of likelihood that communication device 110 is not in sufficient compliance, communication device 110 can not be connected to destination network 170 but connects to compliance network 150. As another example, when it is clear (i.e. there exists at least a predetermined level of likelihood) that communication device 110 is in sufficient compliance, communication device can in some cases be connected to destination network 170 (and optionally can be also be connected to compliance network 150). As another example, assume communication device 110 is connected to stopover network 198 due to earlier insufficient compliance. Assume also that there is reason to believe that communication device 110 may currently be able to connect or may currently be able to be remedied so as to be able to connect with destination network 170, but that the current likelihood of insufficient compliance for communication device 110 is above a predetermined level. In this example, communication device 110 may first be checked by compliance network 150 (and would not connect to destination network 170 until sufficient compliance is confirmed). In this latter example, communication device 110 may be connected to stopover network 198 while connected to compliance network 150, or may have to reconnect to compliance network 150 in order to be checked.

The way that communication device 110 determines the likelihood of not being in sufficient compliance and/or likelihood of being in sufficient compliance can vary depending on the embodiment, and can include for example consideration of one or more conditions internal to communication device 110 and/or external to communication device 110. The conditions may include one or more of the following inter-alia: time since last connection to compliance network 150 (which may in some cases be equivalent to time validity of a previously received pass—see below), changes in configuration of communication device 110 since the last connection to compliance network 150, and communication device 110 suspecting or assuming insufficient compliance. For example, one or more of the following inter-alia may cause communication device 110 to suspect or assume insufficient compliance: verification failure of software integrity of communication device 100 by checksum or message digest, result of specific checks as defined in policy for the presence or absence of running software, the version of third party software is less than that required by policy, the presence or absence of data files or software installations as required by a policy, and detection of an attempt to interfere with intended operation of communication device 110 (for example the use of a command line utility not enabled by policy, an attempt to shut down the persistent portion of the software on client device 110, or an attempt to block or subvert communications between components of communication device 110, etc).

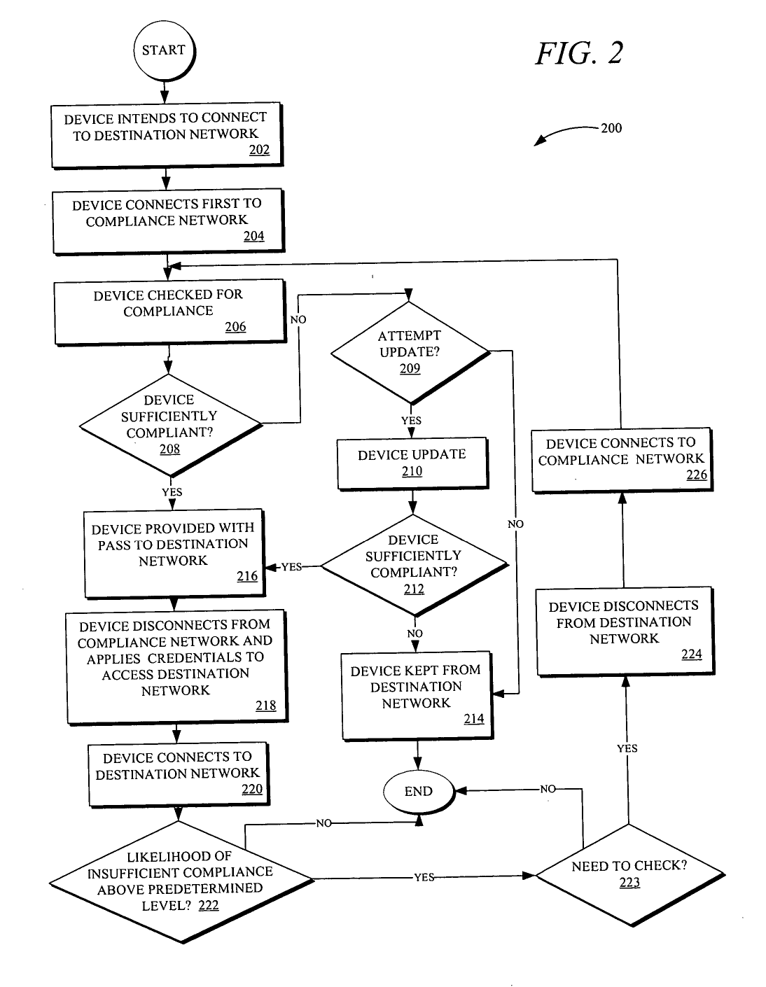

FIG. 2 shows a method for dynamic network connection based on compliance, according to an embodiment of the present invention. The invention is not bound by the specific stages or order of the stages illustrated and discussed with reference to FIG. 2. It should also be noted that alternative embodiments can include only selected stages from the illustrated embodiment of FIG. 2 and/or additional stages not illustrated in FIG. 2.

In stage 202, communication device 110 intends to connect to destination network 170. For example, the user of communication device 110 may provide an indication of a desire to connect to destination network 170. Continuing with this example, the user may press a “connect” button on a graphical user interface GUI of communication device 110 to connect to destination network 170. As another example, an application on communication device 110 may require connection to destination network 170.

In some embodiments, assuming the likelihood of insufficient compliance is determined to be above a predetermined level, as discussed above, method 200 proceeds with stage 204. If the likelihood of sufficient compliance is determined to be above a predetermined level, method 200 may in some embodiments instead proceed directly to stage 220 (i.e. communication device 110 connecting to destination network 170). For example, in one of these embodiments if the likelihood of sufficient compliance is determined to be above a predetermined level, the user may have the option of proceeding with stage 204 or proceeding directly to stage 220.

In one of these embodiments, communication device 110 first performs any processes which communication device 110 is capable of performing which could possibly increase the likelihood of communication device 110 being sufficiently in compliance. Only then in this embodiment would communication device make a determination on whether the likelihood of communication device 110 being insufficiently compliant is above a predetermined level and stage 204 should follow.

In another embodiment, regardless of whether the likelihood of insufficient compliance is above a predetermined level, method 200 continues with stage 204. In this embodiment, each time communication device 110 intends to connect to destination network 170 in stage 202, method 200 continues with stage 204.

In stage 204, communication device 110 connects first to compliance network 150. Depending on the embodiment, communication device 110 may require, none, one or a plurality of pre-assigned credentials in order to connect to compliance network 150.

In stage 206, compliance network 150 checks if communication device 110 is sufficiently in compliance with the up-to-date policies of destination network 170. For example, compliance network 150 may perform one or more of the following inter-alia: run vulnerability scans and/or security scans such as Nessus which looks for vulnerabilities (available at www.nessus.org), check the antivirus database version, check the operating system patch level, check for the presence or absence of running programs, check for the presence or absence of installed programs or other data, check for the presence or absence of listening TCP or User Datagram Protocol UDP ports, observe TCP and UDP traffic from device 110 using intrusion detection systems such as Snort (available at www.snort.org), and file checksums or message digest as provided through an interface in the client software.

If communication device 110 is considered sufficiently in compliance in stage 208 based on the findings of the compliance checking of stage 206, communication device 110 is provided with a pass to access destination network 170 in stage 216 (see below explanation of stage 216). If communication device 110 is not considered sufficiently in compliance, method 200 continues with stage 209.

In some embodiments, communication device 110 may be considered sufficiently in compliance even if updates exist. For example in some of these embodiments, if no advisory/mandatory updates are desirable/necessary then regardless of whether optional desirable updates are available, communication device 110 may be considered sufficiently in compliance. Optionally in these embodiments an exception report may be generated if optional updates are available, for example by compliance network 150. As another example in another of these embodiments, if there are advisory and/or optional updates that are desirable but not readily available to compliance network 150, communication device 110 may be considered sufficiently compliant. In other embodiments, when any updates exist and/or are readily available even if optional, communication device 110 is not considered sufficiently in compliance.

In stage 209, it is determined if an attempt should be made to solve any non-compliance by trying to update communication device 110. If it is determined that no updating should be attempted then communication device is kept away from destination network 170 in stage 214 (see below explanation of stage 214)

For example, in some embodiments, an attempt at update may not be attempted (stage 209) for one or more of the following reasons inter-alia: any updates for rendering communication device 110 sufficiently in compliance are not readily available to compliance network 150 (for example because there is not yet a solution to a newly discovered virus which has infected communication device 110), communication device 110 is suspected/determined to be an intruder, software of communication device 110 is compromised and the installation is in a terminal state, and communication device 110 is trying to masquerade as an authentic client and can not complete the compliance checking process.

If it is determined that an attempt at updating should be made, then in stage 210 communication device 110 receives one or more updates from compliance network 150. The determination of which updates to provide is based on the findings of the compliance checking of stage 206. For example, in some embodiments, communication device 110 receives all mandatory and/or advisory updates that are readily available to compliance network 150. As another example, in one embodiment communication device 110 receives optional available updates in stage 210 regardless of whether mandatory/advisory updates are available because communication device 110 is not considered sufficiently compliant without the optional updates. In another embodiment, communication device 110 only receives optional updates in stage 210 if mandatory/advisory updates are also being received.

Depending on the embodiment, updates received in stage 210 can include one or more of the following inter-alia: new items for communication device 110 such as new software, new versions of existing items, patches, antivirus database updates, spyware removal database updates, VPN connection profiles, X.509 certificates, certificate revocation lists (CRLs), encryption keys (public, shared, and/or private), software removal, software resets, hardware or device driver disconnection and fix scripts, as required to enforce the security compliance policy. The updates when applied reconfigure attributes of communication device 110 to conform with the up-to-date policies of destination network 170.

In stage 212 compliance network determines if the received updates have rendered communication device 110 sufficiently in compliance. If yes, communication device 110 is provided in stage 216 with a pass required to access destination network 170. Optionally, prior to the pass being provided or made effective, device reconnection and/or rechecking may be required as described herein above.

Communication device 110 may be considered insufficiently compliant in stage 212 for any reason, depending on the embodiment. Examples of reasons include one or more of the following inter-alia: software of communication device 110 is compromised and the installation is in a terminal state, and one or more updates (for example patches) to third party software such as anti-virus, personal firewall, or spyware have failed to be received by communication device 110.

In some embodiments, communication device 110 is considered sufficiently compliant in stage 212 if all mandatory updates have been successfully received, regardless of whether any provided advisory and/or optional updates have been successfully received. For example, assuming that in one of these embodiments that it is mandatory that the ISS RSDP runs, then if the updating in stage 210 fails to allow the ISS RSDP to run, then in this embodiment, communication device 110 will not be considered sufficiently in compliance. As another example, assume that in one of these embodiments it is advisory that a login warning be present, then if the updating of state 210 fails to cause the login warning to be present, communication device 110 may still be considered sufficiently in compliance (provided there are no other compliance issues). Even if communication device 110 is considered sufficiently in compliance, an exception report may be prepared, for example by compliance network 150, if an update has not been successfully received by communication device 110.

If communication device 110 is determined to not be sufficiently compliant in stage 212, communication device 110 is kept away from destination network 170 in stage 214.

Depending on the embodiment stage 214 can comprise one or more of many actions as long as communication device 110 is kept away from destination network 170. For example in one embodiment, in stage 214 compliance network 150 provides communication device 110 with a pass to stopover network 198, for example a quarantine network. Continuing with this example, communication device 110 may be retained at stopover network 198 until compliance network 150 is capable of solving the non-compliance upon which communication device 110 may be rendered sufficiently compliant. Still continuing with this example, communication device 110 may or may not have also been connected with compliance network 150 while connected to stopover network 198 and therefore may or may not need to reconnect with compliance network 150 in order to be rendered sufficiently compliant. As another example in another embodiment, in stage 214 compliance network 150 maintains a connection with communication device 110 until communication device 110 can be rendered sufficiently compliant. As another example in another embodiment, in stage 214 compliance network 150 does not provide communication device 110 with a pass for destination network 170 but allows communication device 110 to disconnect from compliance network 150.

In one embodiment, method 200 ends if stage 214 is executed, and in order for communication device 110 to again attempt to reach destination network 170, method 200 is re-executed from the beginning. In another embodiment, once stage 214 is executed, there is a monitoring for a change in circumstances which may enable compliance network 150 to correct the non-compliance of communication device 110 which was determined in stage 212. If a change is detected a check is made for updates. If updates are available to compliance network 150 then stage 210 and the stages which follow are executed. The check can be specifically for updates which would solve the non-compliance determined in stage 212 or can be a general check for any updates which may or may not solve the non-compliance determined in stage 212. In another embodiment, once stage 214 is executed there is instead or in addition a monitoring for a change in circumstances which may have rendered communication device 110 sufficiently in compliance, and if a change is detected then stage 208 and the stages which follow are executed.

In stage 216 a pass is provided to communication device 110 by compliance network 150. The pass allows communication device 110 to access destination network 170. The pass provided in stage 216 to allow communication device 110 to access destination network 170, or alternatively the pass optionally provided in stage 214 for stopover network 198 can be any resource which allows communication device 110 to establish a connection to destination network 170 (or alternatively stopover network 198). Examples of methods of providing passes include one or more of the following inter-alia: using the Kerberos authentication protocol which includes provision of digital identifying tickets and secret cryptographic keys (available at web.mit.edu/Kerberos), providing a pre-shared key, providing a client certificate which expires at a particular time in the future, providing the location of a VPN server and associated shared password thereof (collectively VPN profile) so that communication device 110 can reach destination network 170 or stopover network 198 (depending on the embodiment, the VPN profile may be erased or may not erased by communication device 100 after use), and generation of a one time password. In some cases the provided pass may impose other conditions for validity, related for example to external conditions such as time and/or to conditions internal to communication device 110, for example which applications are installed and/or running, whether there have been any changes in configuration since the last connection to compliance network 150, etc. For example in one embodiment, the pass to access destination network 170 may have a limited-validity which allows communication device 110 to connect destination network 170 within a predetermined time frame (where the clock runs for example from the time the pass was received by communication device 110) or on a one-time or otherwise limited-number-of-times basis.

Any method of creating passes may be used. For example, in one embodiment, the pass provided to communication device 110 in stage 216 (or stage 214 for stopover network 198) may involve predetermined credentials (for example username/password, VPN profile, etc). The credentials may have been determined previously and set in both compliance network 150 and destination network 170 (or stopover network 198), or alternatively a means for generation of credentials based on a common algorithm may have been set in both compliance network 150 and destination network 170 (or stopover network 198). In another embodiment, compliance network 150 generates shared credentials—a pass that is provided to communication device 110 and a corresponding pass which is provided to destination network 170 (or stopover network 198). In another embodiment, compliance network 150 requests a ticket from an outside ticketing system. The ticket is passed to communication device 110 in stage 216 (or 214) and presented to destination network 170 (or stopover network 198) for authentication. Destination network 170 (or stopover network 198) presents the ticket to the ticketing system for validation. Since the realm of the ticket includes both compliance network 150 and destination network 170 (or stopover network 198), mutual authentication is achieve.

Depending on the embodiment, the level of isolation between compliance network 150 and destination network 170 may vary and the level of isolation between compliance network 150 and optional stopover network 198 may vary. In some cases as explained above, in addition to the pass provided to communication device 110, a corresponding pass, for example a one-time pass, may be provided in stage 216 to destination network 170 or in stage 214 to stopover network 198 in order to allow a connection between communication device 110 and either destination network 170 or stopover network 198. In these cases, there may therefore be some degree of connection between compliance network 150 and destination network 170 and/or between compliance network 150 and stopover network 198. In other cases, no corresponding pass may be provided to destination network 170 or stopover network 198, for example when predetermined passwords or very strong authentication is used, and therefore in these cases the isolation between compliance network 150 and destination network 170 and/or between compliance network 150 and stopover network 198 may be more complete.

The reader will appreciate that because device-compliance connection 125 and device-destination connection 175 are different (i.e. not identical), malicious tampering with compliance network 150 is less likely to compromise destination network 170 than in the related art where compliance is checked and remedied by a gateway to the destination network. In some embodiments additional security measures to protect the passes may be used so that malicious tampering with compliance network is even less likely to compromise destination network 170. For example, in one embodiment, the passes are protected by encryption and only released by compliance network 150 in stage 216 after communication device 110 has passed inspection (i.e. determined to be sufficiently in compliance). In another embodiment, the pass is generated by cryptographic computations in stage 216 only after communication device 110 has passed inspection. In another embodiment, passes are not stored at compliance network 150 and an outside ticketing system is used for mutual authentication.

In stage 218 communication device 110 optionally disconnects from compliance network 150. Also optionally in stage 218, any received credentials are applied before connection to destination network 170 in stage 220. The reader will appreciate that in embodiments where received updates are applied prior to the connection to destination network 170, there is a significant advantage over the related art where updates are typically received from a gateway to the destination network and typically only applied after disconnection from the destination network. In embodiments where disconnection from compliance network 150 does not occur prior to connection to destination network 170, any received updates are applied when disconnection from compliance network 150 occurs.

In stage 220, communication device 110 connects to destination network 170 using the pass received in stage 216. Without the pass, communication device 110 would be unable to connect to destination network 220.

Depending on the embodiment, communication device 110 may require besides the pass provided in stage 216 additional authentication to connect to destination network 170 in stage 220, for example a shared secret, login user name and password, etc.

Once communication device 110 has connected to destination network 170 in stage 220, communication device 110 optionally monitors one or more predetermined conditions in stage 222 in order to attempt to discover if the likelihood of insufficient compliance at some point exceeds a predetermined level. Depending on the embodiment, the monitoring can be continuous, periodic or only when triggered by predetermined events (for example when a new application is installed on communication device 110). Monitored conditions can include external and/or internal conditions. Examples of monitored conditions include one or more of the following inter-alia: elapsed time (if the received pass was for a limited time duration), changes in configuration at communication device 110, verification results of software integrity of communication device 100 by checksum or message digest, results of specific checks as defined in policy for the presence or absence of running software, the version of third party software compared to the version required by policy, the presence or absence of data files or software installations as required by a policy, and attempts to interfere with intended operation of communication device 110 (for example the use of a command line utility not enabled by policy, an attempt to shut down the persistent portion of the software on client device 110, or an attempt to block or subvert communications between components of communication device 110, etc).

If the likelihood of insufficient compliance remains below a predetermined threshold, the connection to destination network 170 continues and method 200 ends when the connection with destination network 170 is stopped, for example when the user desires to disconnect or when an application on communication device 110 no longer requires access to destination network 170. If during the monitoring of stage 222 the likelihood of insufficient compliance exceeds a predetermined level, method 200 continues with stage 223.

In stage 223, it is determined if the results of the monitoring of stage 222 calls for a recheck for compliance of communication device 110 by compliance network 150. If yes, communication device 110 is disconnected from destination network 170 in stage 224. Communication device 110 is optionally reconnected to compliance network 150 in stage 226, and method 200 repeats stages 206 through 222. The updates received in state 210 can be specifically updates which would solve any discovered conditions that contributed to the likelihood of non-compliance exceeding a predetermined level during the monitoring of the previous round of stage 222 or can be any updates which may or may not be related to any conditions that caused the likelihood of non-compliance to exceed a predetermined level. If communication device 110 had been still connected to compliance network 150 during the connection with destination network 170, stage 226 can be omitted.

If in stage 223, it is determined that the results of the monitoring of stage 222 do not call for a recheck for compliance of communication device 110 by compliance network 150, then method 200 ends after communication device 110 performs any actions to solve the non-compliance. For example, assume a policy of no instant messaging to outsiders without permission to access destination network 170, while connected to destination network 170. In this case, if while connected to destination network 170, communication device 110 attempts to instant message an outsider, communication device 110 may prevent the instant messaging from occurring but may not need to be checked by compliance network 150 because the non-compliance may be considered to have been sufficiently solved by preventing the instant messaging. As another example if a program, for example a virus program, crashes once, communication device 110 may attempt to solve the non-compliance without the assistance of compliance network 150 whereas if the program crashes numerous times communication device may disconnect from destination network 170 in stage 224 in order to be checked by compliance network 150.

In an alternative embodiment, in some cases when it is determined in stage 223 that the results of the monitoring of stage 222 do not call for a recheck for compliance of communication device 110 by compliance network 150, communication device 110 may still disconnect from destination network 170 prior to performing any actions to solve the non-compliance.

In an alternative embodiment, if in stage 222 it is determined that the likelihood of insufficient compliance exceeds a predetermined level, communication device 110 disconnects from destination network 170 and method 200 ends. To reconnect, method 200 must be followed again from the start.

In alternative embodiments, stages 222 through 226 are omitted and no monitoring of non-compliance is performed. Instead, a check for compliance is only made the next time stage 208 is executed (i.e. when a new connection to destination network 170 is intended).

In alternative embodiments, communication device 110 can be connected to compliance network 150 at any time and optionally all the time, and therefore stages 204 and 226 may be unnecessary. In these alternative embodiments, stage 206 may in some cases follow directly after stage 202 and stage 206 may in some cases follow directly after stage 224.

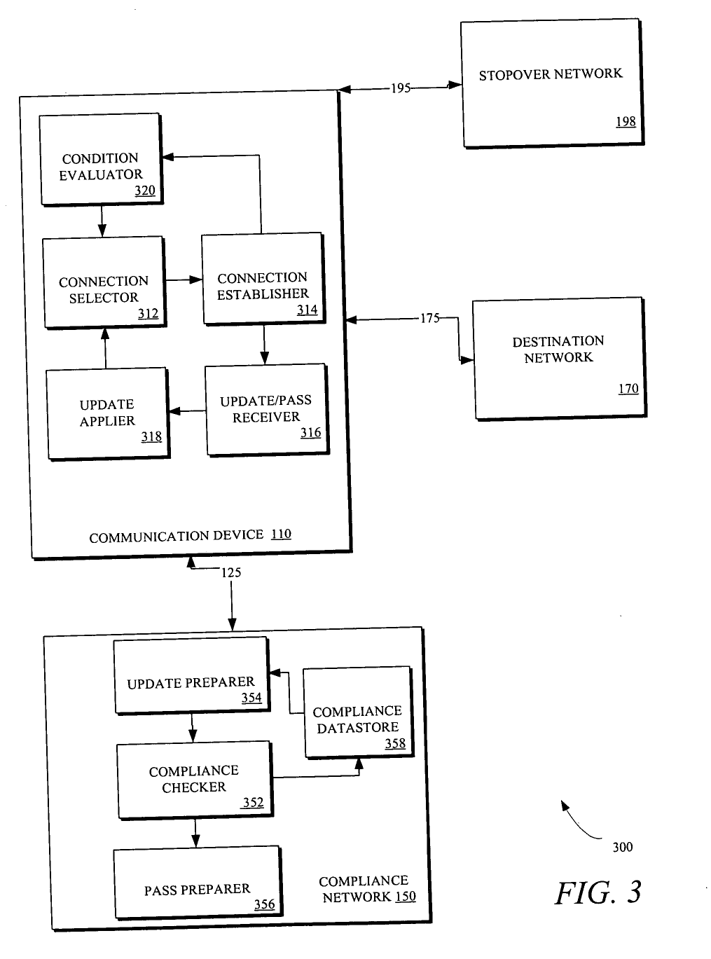

FIG. 3 is a block diagram 300 illustrating modules of communication device 110 and compliance network 150, according to an embodiment of the present invention.

In the embodiment illustrated in FIG. 3, communication device 110 includes a connection selector module 312, a connection establisher module 314, an update/pass receiver module 316, an update applier module 318, and a condition evaluator module 320. Modules 312, 314, 316, 318, and 320 can each be made of any combination of software, hardware and/or firmware that performs the functions as defined and explained herein. In some embodiments, communication device 110 includes additional modules and/or excludes some of the modules illustrated in FIG. 3. In some embodiments, some of the modules illustrated in FIG. 3 as being included in communication device 110 may instead be included in another part of FIG. 3. The division of communication device 110 into the modules shown in FIG. 3 is for ease of understanding and in other embodiments any of the modules may be separated into a plurality of modules or alternatively combined with any other module.

In the embodiment illustrated in FIG. 3, compliance network 150 includes a compliance checker module 352, an update preparer module 354, one or more compliance datastore 358 and an optional pass preparer module 356. Modules 352, 354, 356, and 358 can each be made of any combination of software, hardware and/or firmware that performs the functions as defined and explained herein. For ease of explanation one compliance datastore 258 is described below, but in alternative embodiments there may be separate datastores 358 for different functions of update preparer 354 and/or compliance checker 352, and in these embodiments similar methods and systems to those described below are used mutatis mutandis.

In some embodiments, compliance network 150 includes additional modules and/or excludes some of the modules illustrated in FIG. 3. In some embodiments, some of the modules illustrated in FIG. 3 as being included in compliance network 150 may instead be included in another part of FIG. 3. The division of compliance network 150 into the modules shown in FIG. 3 is for ease of understanding and in other embodiments any of the modules may be separated into a plurality of modules or alternatively combined with any other module. As mentioned above, depending on the embodiment compliance network 150 may be concentrated in one location or parts of compliance network 150 may be distributed over more than one location. For example in one embodiment, compliance network 150 includes in addition to compliance datastore 358 two servers: a policy download service (corresponding to update preparer module 354) and a security monitoring, scanning, patching, and ticketing service (corresponding to compliance checker 352 and optionally to pass preparer 356) which can be integrated together, located in the same location or located in different locations. In another embodiment, the functionality of these two servers is divided among fewer or more separate machines.

An example of operation using the modules illustrated in FIG. 3 is now presented. In one embodiment, connection selector 312 first selects a connection with compliance network 150 either whenever communication device 110 aims to connect to destination network 170 or alternatively under predetermined circumstances where the likelihood of insufficient compliance exceeds a predetermined threshold (as evaluated by conditions evaluator 320). In this embodiment, connection establisher 314 connects to compliance network 150 via device-compliance connection 125, upon which compliance checker 352 checks if communication device 110 is in sufficient compliance with the up-to-date policies of destination network 170. Update preparer 354 optionally prepares any updates from datastore 358. Pass preparer 356 optionally prepares any passes for accessing destination network 170 or stopover network 198 (as explained above the passes may for example be predetermined, shared, or ticketed). Update/pass receiver 316 receives any updates and/or passes from compliance network 150. (If updates were sent and received, compliance checker 352 may optionally recheck for compliance, pass preparer 356 or an outside ticketing system may optionally prepare any newly appropriate passes and update/pass receiver 316 may optionally receive those passes). Based on the type of pass received (if any), connection selector 312 selects a new (appropriate) connection and connection establisher 314 establishes the appropriate connection. Continuing with this embodiment, if the received pass is for destination network 170, communication device 110 connects to destination network 170 via device-destination connection 175. Update applier 318 applies any received updates, for example prior to the establishment of the new connection. Once the new connection has been established, condition evaluator 320 checks while the connection is outstanding whether there is any reason to suspect a change in conditions (causing a change in the likelihood of sufficient compliance) which requires another connection selection by connection selector 312 and/or a disconnection from the current connection. For example, if a virus has been discovered on communication device 110, communication device 110 may disconnect from destination network 170 and connection-establisher 314 may if necessary connect to compliance network 150 via device-compliance connection 125 in order to attempt to receive an update which treats the virus. As another example, assuming a connection had been established with stopover network 198 which in this example is a quarantine network. If condition evaluator 320 suspects that quarantine may no longer be necessary, connection establisher 314 may if necessary connect to compliance network 150 to check the current compliance of communication device 110.

Depending on the embodiment, connection selector 312 may select only one connection at a time, or may allow simultaneous connections. For example, in one embodiment, if the likelihood that communication device 110 is sufficiently compliant is above a predetermined level, connection selector 312 may allow connection establisher 314 to establish a connection to destination network 170 in addition to other connections such as to compliance network 150, but if the likelihood of insufficient compliance is above a predetermined level, connection selector 312 may allow a connection to compliance network 150 but not a connection to destination network 170 (i.e. exclusive of destination network 170).

As noted above, different ones of the described functions may be provided by different ones of the described components. In another embodiment of the invention, one or more features of the compliance network may be contained and/or duplicated within and operated by destination network 170. For example, to provide ongoing security, an additional compliance checker such as checker 352 may be associated with and operated by destination network 170. The destination network can thus continuously monitor ongoing compliance by device 110. In the event that communications device 110 is determined to be out of compliance while connected to destination network 170, the device may be disconnected from the network and required to reconnect to and prove compliance within compliance network 150 in the manner described herein.

As mentioned above, one of the features of the invention is the distinction (i.e. independence) between device-compliance connection 125 and device-destination connection 175. Device-compliance connection 125 and device-destination connection 175 are independent of one another even in cases where there is sharing of some elements (but not all elements) between device-compliance connection 125 and device-destination connection 175. Some embodiments further describing connections 125 and 175 will now be elaborated upon. In the embodiments described below, it is assumed for ease of description that stopover network 198 and device-stopover connection 195 are not present, but in embodiments including stopover network 198 and device-stopover connection 195 similar systems and methods to those described below can be used, mutatis mutandis.

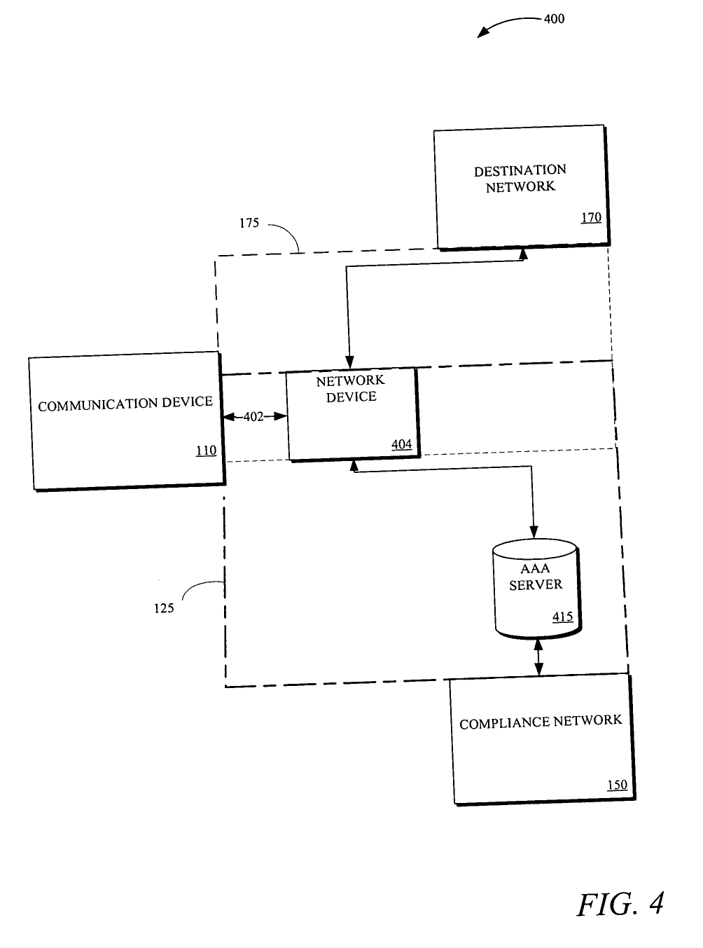

FIG. 4 is a block diagram of a configuration 400 which further elaborates upon device-compliance connection 125 and device-destination connection 175, according to an embodiment of the present invention. In the illustrated embodiment, device-destination connection 175 includes a (wired or wireless) physical link 402 and a network device 404. Device-compliance connection 125 includes link 402, network device 404 and an authorization, authentication and accounting AAA server 415. In one embodiment, configuration 400 is used in a local area network or campus scenario.

Network device 404 can be any suitable device which allows data from communication device 110 to be transferred to either destination network 170 or to compliance network 150, as appropriate, in accordance with method 200. In the description here, when network device 404 directs data from communication device 110 which is destined for destination network 170 to destination network 170, communication device 110 is considered connected to destination network 170. Similarly, when network device 404 directs data from communication device 110 which is destined for compliance network 150 to AAA server 415 (and thereby to compliance network 150), communication device 110 is considered connected to compliance network 150. Examples of network devices 404 include inter-alia: routers, proxy servers, firewalls, wireless access points, network switches, and network bridges.

In one embodiment, AAA server 415 is a Remote Authentication Dial-In User Service (RADIUS) server, where RADIUS is a widely deployed protocol for AAA servers. Other embodiments could use other types of authentication such as Diameter, Lightweight Directory Access Protocol LDAP, Windows NT LAN Manager (NTLM), or any other suitable authentication types.

For ease of explanation, it will be assumed that all AAA servers described here and below are RADIUS servers and that the authentication protocol used is the RADIUS protocol, but in embodiments where other authentication types are utilized similar methods and systems to those described below can be used, mutatis mutandis.

As RADIUS servers are well known to the reader, only certain attributes of the protocol are described below. The following RADIUS message types are relevant to the description and are therefore listed here:

1. Access-Request. Sent by a RADIUS client to request authentication and authorization for a network access connection attempt.

2. Access-Accept. Sent by a RADIUS server in response to an Access-Request message. This message informs the RADIUS client that the connection attempt is authenticated and authorized.

3. Access-Reject. Sent by a RADIUS server in response to an Access-Request message. This message informs the RADIUS client that the connection attempt is rejected. A RADIUS server sends this message if either the credentials are not authentic or the connection attempt is not authorized.

4. Access-Challenge. Sent by a RADIUS server in response to an Access-Request message. This message is a challenge to the RADIUS client that requires a response.

For example, in the RADIUS protocol, an access challenge message may be responded to with an access-request message that has credentials to answer the challenge. Here and below this type of access request is termed “challenge response” for ease of understanding.

In the illustrated embodiment, in operation, communication device 110 attempts to authenticate to network device 404 using any protocol suitable for link 402 and compatible with network device 404. Examples of protocols that can be used depending on the embodiment include inter-alia: link-level, web page authentication (to a walled garden, for example a Wi-Fi hotspot, hotel broadband, etc.) a network protocol that supports challenge response (for example HTTP basic authentication (RFC 2045), FTP (RFC 959), etc), etc. Network device 404, acting as a RADIUS client to RADIUS server 415, sends access requests (including inter-alia challenge responses) to RADIUS server 415 and receives access challenges from RADIUS server 415. In one embodiment, the protocol used to authenticate to network device 404 and the RADIUS specifications specify that an unlimited number of access-challenge/challenge response messages may be exchanged, thus creating a means for data interchange between communication device 110 and compliance network. 150 in the authentication protocol conversation. In some embodiments data payloads between communication device 110 and compliance network 150 are tunneled in the attributes appropriate to the RADIUS packet type. For example in one of these embodiments data payloads are transferred in the User-Password attribute in the challenge response message and in the Reply-Message attribute in the access-challenge message. The tunneling may be accomplished by any established tunneling method used in networking.

For example, stages 206 to 216 may be executed during the authentication protocol conversation with any updates (in stage 210) from compliance network 150 tunneled as data payloads in packets of the authentication protocol messages. In one embodiment, RADIUS server 415 executes one or more of the following functions as part of stage 210: server 415 receives and prepares an update request from communication device 110, server 415 forwards the update request to compliance network 150, and server 415 handles the transmission of update data to communication device 110.

At the end of transmission, communication device 110 may determine that updates have been received and request that network device 404 transmit a final Access-Request (indicating that updates have been received). In one embodiment, communication device 110 may determine that the end of transmission has occurred because of there is a block-oriented communications protocol with checksums and retransmission capability, and an end-of-transmission marker. The final access request may optionally contain keying information generated by cryptographic operations as part of the update process, to validate the application of updates.

In one embodiment, once the final access request indicating receipt of all updates is received by radius server 415, compliance network 150 may check if communication device 110 is sufficiently compliant (stage 212) and optionally prepare appropriate credentials (i.e. the appropriate pass). Alternatively, if no updates are attempted (yes to stage 208 or no to stage 209), compliance network 150 may optionally prepare appropriate credentials to reach the appropriate network. These credentials (i.e. the appropriate pass) are transmitted by server 415 in an access accept message as part of the authentication protocol conversation in stage 216 (where the pass here is for accessing destination network 170) or in stage 214 (in embodiments where stopover network 198 is present and the pass is for accessing reach stopover network 198). In another embodiment, if communication device 110 is judged to be insufficiently compliant in stage 212, an access reject message may be sent (i.e. in stage 214 not allowing communication device 110 onto network 170).

It should be evident to the reader that a feature of configuration 400 of FIG. 4 is that the authentication protocol conversation is used to transmit information other than authentication related data. Typically although not necessarily authentication related data includes the user identification and password in access request messages and success/failures included in access accept/reject/challenge messages. Specifically in configuration 400, the authentication protocol conversation includes inter-alia data related to whether communication device 110 is sufficiently compliant to access destination network 170 and optionally data (i.e. one or more updates) to render communication device 110 in sufficient compliance.

In one embodiment, communication device 110 has access limited to authentication traffic in a protocol compatible with network device 404 and establishes TCP/IP communications only once connected to destination network 170.

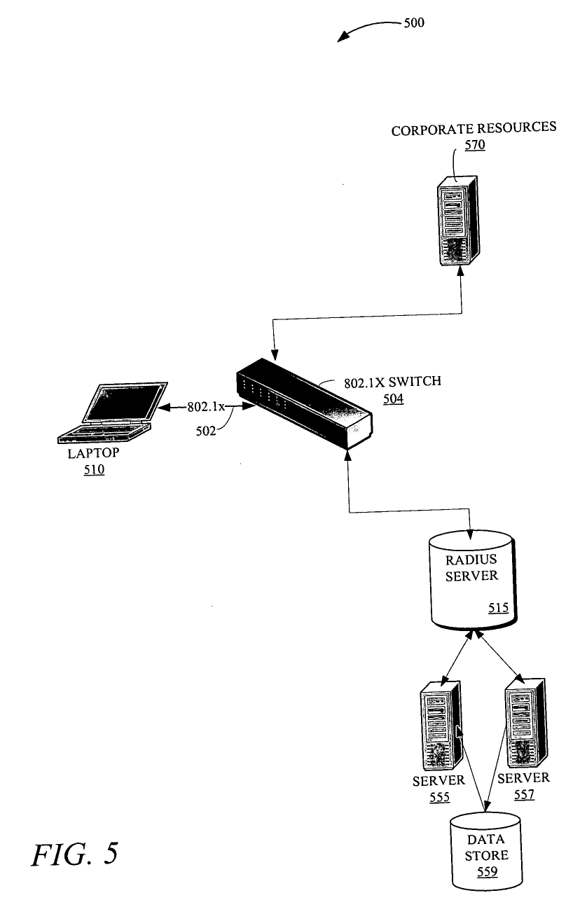

FIG. 5 is a block diagram 500 illustrating an example of configuration 400, in a wireless environment where destination network 170 is a corporate local area network LAN, according to an embodiment of the present invention. In the illustrated embodiment, link 402 is a wireless link 502, conforming for example with the IEEE 802.1x standard (i.e. the protocol is a link-level protocol). Network device 404 is an 802.1x switch 504. Communication device 110 is a wireless device 510, such as laptop configured to connect to switch 504 via link 502. Destination network 170 includes corporate resources 570. AAA server 415 is a RADIUS server 515. Compliance network 150 includes a policy download server 555, a security monitoring, scanning, patching and ticketing server 557, and a datastore 559. Switch 504, for example matches the media access control MAC address of wireless device 510 in order to associate the MAC address with either destination network 170 or RADIUS server 415, for example using VLAN assignment. In one embodiment, the Extensible Authentication Protocol (EAP) which encapsulates authentication methods inside of a RADIUS payload is used to authenticate remote users, in accordance with the IEEE 802.1x standard for network port authentication which defines how Extensible Authentication Protocol (EAP) can be used by IEEE 802 devices (including inter-alia IEEE 802.11b (WiFi) wireless access points and Ethernet switches) to authenticate remote users.

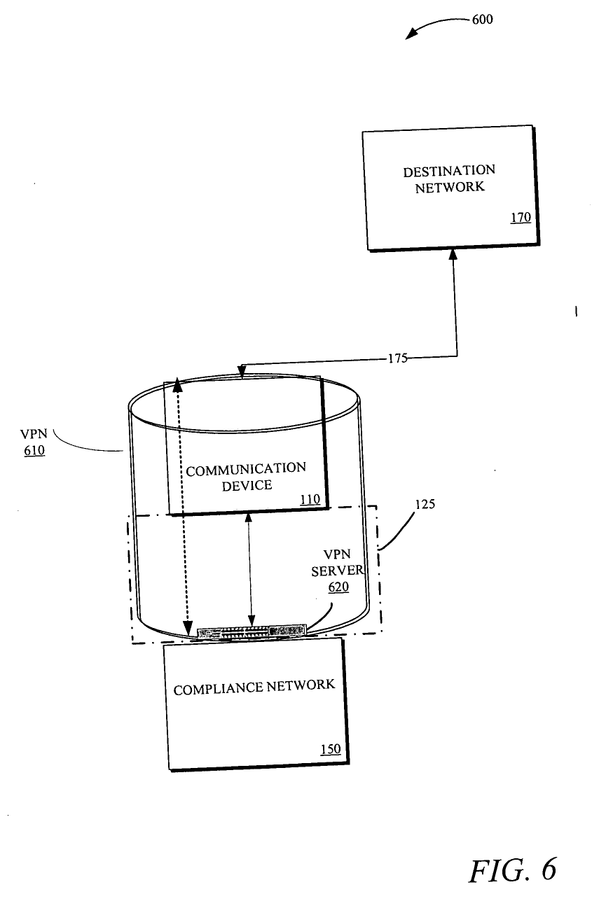

FIG. 6 is a block diagram of a configuration 600 further elaborating upon device-compliance connection 125 and device-destination connection 175, according to another embodiment of the present invention. The illustrated embodiment uses a compliance virtual private network VPN 610, whose endpoints include communication device 110 and compliance VPN server 620. As will be understood by the reader, compliance VPN 610 is an extension of a private network that encompasses links across shared or public networks like the Internet, enabling the transfer of data between communication device 110 and compliance network 150 across a shared or public inter-network in a manner that emulates one or more of the properties of a point-to-point private link. For example, in one embodiment in order to emulate a point-to-point link, data is encapsulated, or wrapped, with a header that provides routing information allowing it to traverse the shared or public transit inter-network to reach its endpoint. As another example, in one embodiment in order to emulate a private link, the data being sent is encrypted for confidentiality. Depending on the embodiment, VPN 610 may additionally or instead provide one or more of the following security measures inter-alia: user authentication, address management, and encryption key management. In the illustrated embodiment, device-compliance connection 125 includes VPN server 620 and the connection between VPN server 620 and communication device 110.

In the illustrated embodiment in operation, stages 206 through 216 are executed while VPN 610 is established. Any updates (from stage 210) and/or passes (from stage 216 or stage 214 in embodiments with stopover network 198) are transported via compliance VPN 610. Once communication device 110 has been judged compliant (with or without receiving any updates), compliance VPN 610 may in one embodiment be torn down as part of stage 218. Compliance VPN 610 thus allows an independent network environment separate from destination network 170 with compliance VPN 610 providing a complete network connection and providing access to all TCP/IP protocols, but precluding access to any other network.

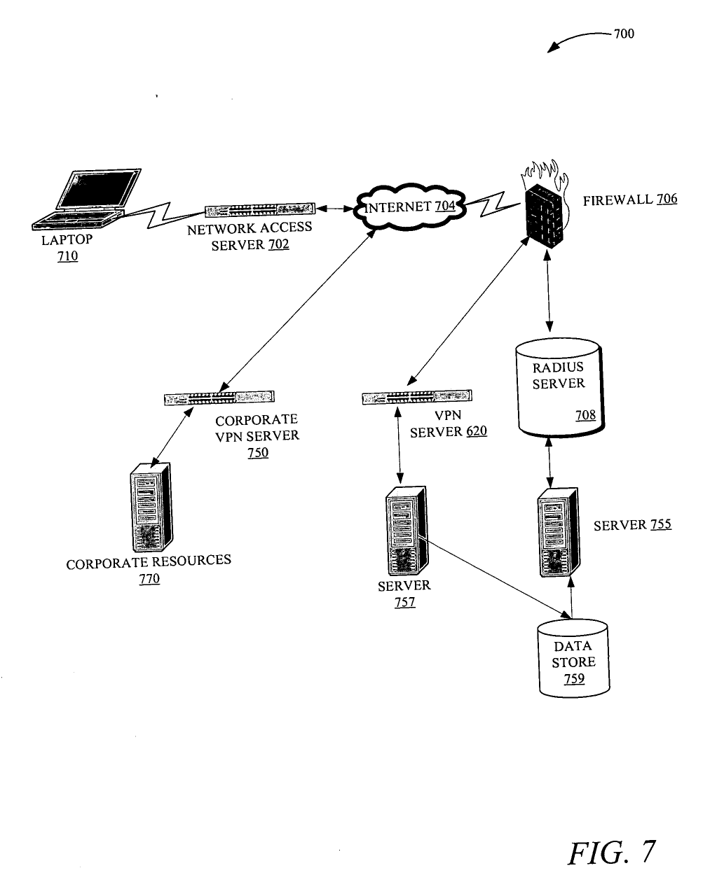

FIG. 7 is a block diagram 700 illustrating an example of configuration 600, according to an embodiment of the present invention. In the illustrated embodiment, communication device 110 is a laptop 710, and device-compliance connection 125 includes network access server 702, Internet 704, and compliance VPN server 620. Compliance VPN 610 includes device-compliance connection 125 (i.e. network access server 702, Internet 704, and compliance VPN server 620) and laptop 710. Device-destination connection 175 includes network access server 702, Internet 704, and corporate VPN server 750. Corporate VPN 745 includes device-destination connection 175 (i.e. network access server 702, Internet 704, and VPN server 750) and laptop 710. Destination network 170 includes corporate resources 770. In another embodiment, destination network 170 can be the Internet (for example unrestricted access) or any computer network which communication device 110 desires to access. Compliance network 150 includes a policy download server 755, a security monitoring, scanning, patching and ticketing server 757, and a datastore 759.

In some embodiments, access by laptop 710 to the Internet on an unrestricted basis may be blocked even while laptop 710 is connected to compliance network 150 via device-compliance connection 125 which includes Internet 704. For example in one of these embodiments, a network adaptor on laptop 710 may be protected by filters which only allow dynamic host configuration protocol DHCP (to configure the network adaptor) and IPSec (for VPN tunnel and configuration). In another embodiment, a network adaptor on laptop 710 may be protected by filters which only permit DHCP and HTTPs for 802.11 hotspot detection and secure socket layer SSL VPN operation.

Optionally for example when using dial up service, in order to be authorized to connect to compliance VPN server 620 via the Internet (i.e. receive credentials to be enabled to perform stage 204), configuration 700 includes RADIUS server 708. In another embodiment RADIUS server 708 may be omitted, for example if credentials are not required, another authentication source is used and/or if access to compliance VPN server 620 is always available, for example for code division multiple access CDMA, digital subscriber line DSL, etc.

In some cases, policy download server 755 may generate a pass for use by corporate VPN server 750 (i.e. the corresponding pass provided to destination network 170 discussed above). In embodiments where RADIUS server 708 is included in configuration 700, the corresponding pass may be placed in RADIUS server 708. Similarly in embodiments with stopover network 198, a pass for use by stopover network 198 may be generated and placed in RADIUS server 708.

In operation, laptop 710 optionally accesses RADIUS server 708 to receive Internet authentication. Laptop 710 then accesses policy download server 755 and security monitoring, scanning, patching, and ticketing server 777 (of compliance network 150) via device-compliance connection 125 in order to be checked for compliance (stage 208) and if necessary and/or desirable in order to receive updates and/or passes (stages 210/214/216). Once the checking and/or receiving are completed, compliance VPN 610 is optionally torn down and any received updates are applied (stage 218). Laptop 710 then accesses corporate resources 770 via device-destination connection 175 (stage 220).

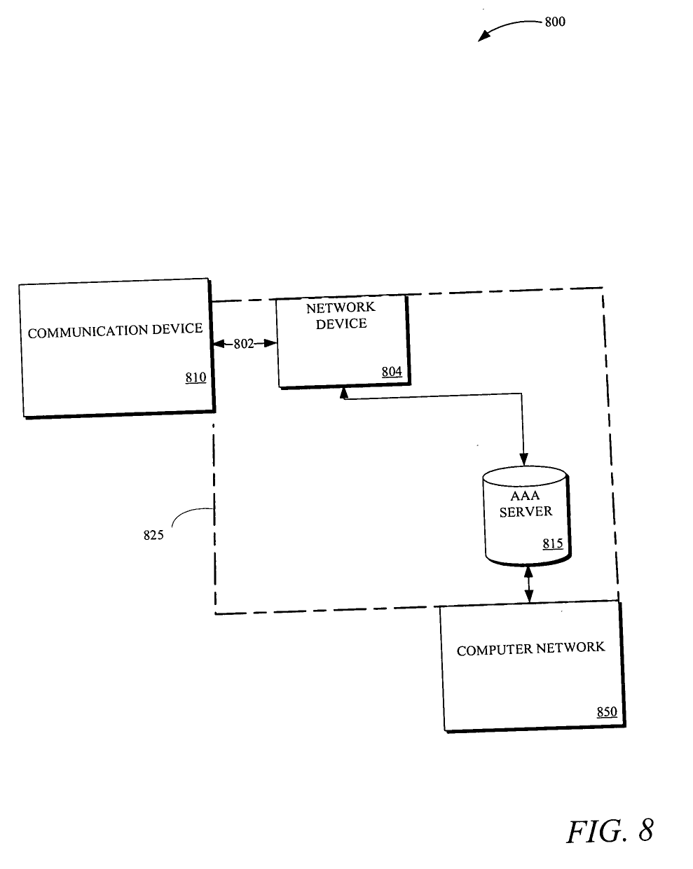

In another aspect of the invention, configuration 400 of FIG. 4 is modified to use the RADIUS challenge request and challenge response messages for any appropriate type of data transfer to and from a communication device 810. FIG. 8 is a block diagram of configuration 800 (modified from configuration 400) for transferring data between a particular computer network 850 and communication device 810 using device-network connection 825, according to an embodiment of the present invention. Communication device 810 may be any combination of software, hardware and/or firmware that is configured to perform the functions as defined and explained herein, including communicating with particular computer network 850. Examples of communication devices 810 include inter-alia cellular phones, pagers, fax machines, telephones, desktop computers, laptop computers, other types of computers, personal digital assistants PDAs, etc. as appropriate to the applicable particular computer network 850. Particular computer network can be any suitable computer network, for example TCP/IP, HDLC, link-level protocols shared with communications device 810, etc. Device-network connection 825 includes a wireless or wired physical link 802, a network device 804 (for example a router, proxy server, firewall, wireless access point, network switch, and/or network bridge) and an authorization, authentication and accounting AAA server 815. AAA server 815 can use any suitable authentication type including inter-alia: RADIUS, Diameter, LDAP, Windows NT LAN Manager (NTLM), but as mentioned above for ease of description all AAA servers are assumed in the description to be RADIUS servers. Optionally link 802 and network device 804 in configuration 800 may also be part of one or more additional connections which connect communication device 810 with other networks. Configuration 800 will be explained in conjunction with a method for transferring data between communication device 810 and particular computer network 850.

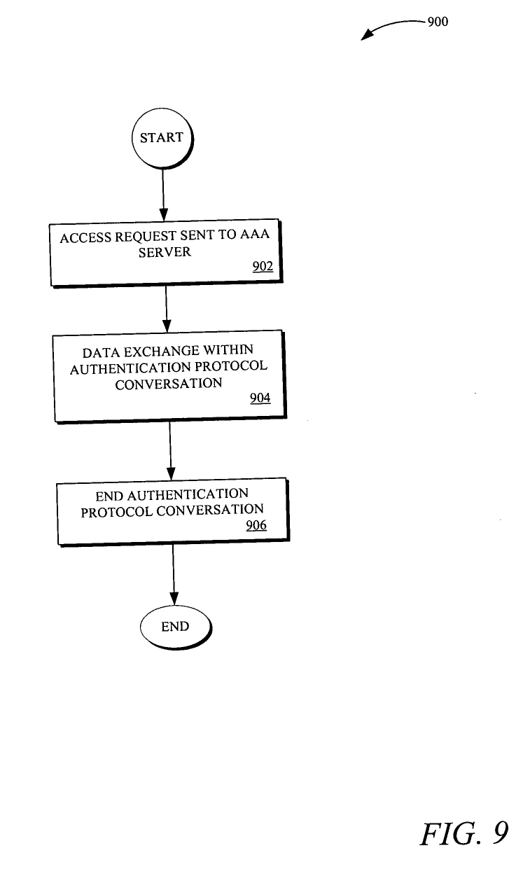

FIG. 9 is a flowchart of a method 900 for transferring data between communication device 810 and particular computer network 850, in accordance with an embodiment of the present invention. The invention is not bound by the specific stages or order of the stages illustrated and discussed with reference to FIG. 9. It should also be noted that alternative embodiments can include only selected stages from the illustrated embodiment of FIG. 9 and/or additional stages not illustrated in FIG. 9.

In stage 902, network device 804, acting as a RADIUS client to RADIUS server 815, transfers an access request to RADIUS server 815. In stage 904, an unlimited number of access challenge/challenge response messages may then be exchanged between network device 804 and RADIUS server 815, thus creating a means for data interchange between communication device 810 and particular computer network 850 in the authentication protocol conversation. In some embodiments data payloads between communication device 810 and particular network 850 are tunneled in the attributes appropriate to the RADIUS packet type, for example in the User-Password attribute in the challenge response message and in the Reply-Message attribute in the access-challenge message. The tunneling may be accomplished by any established tunneling method used in networking. In stage 906, once any desired or required transfer of data between communication device 810 and particular network 850 has been completed, the authentication protocol conversation ends. For example, in one embodiment, communication device 810 may determine that all data has been transferred (for example because there is a block oriented communications protocol with checksums and retransmission capability and an end of transmission marker). Therefore communication device 810 may request that network device 804 transmit a final Access-Request. The final access request may optionally contain keying information generated by cryptographic operations. Continuing with the example RADIUS server 815 may optionally authenticate or decline to authenticate using an access accept or access reject message as part of the closing of the authentication protocol conversation.

It should be evident to the reader that a feature of configuration 800 of FIG. 8 and method 900 is that the authentication protocol conversation is used to transmit information other than authentication related data. Typically although not necessarily authentication related data includes the user identification and password in access request messages and success/failures included in access accept/reject/challenge messages. Specifically in configuration 800 and method 900, the authentication protocol conversation can be used to transport any appropriate type of data between communication device 810 and particular computer network 850.

While the invention has been described with respect to a limited number of embodiments, it will be appreciated that it is not thus limited and that many variations, modifications, improvements and other applications of the invention will now be apparent to the reader.

What is claimed is:

1. A system for enabling compliance of a communication device with the policies of a destination network, comprising:
a communication device configured to connect to a compliance network;
said compliance network configured to check whether said communication device is sufficiently in compliance with at least one predetermined policy of a destination network and to not allow said communication device to connect with said destination network if said communication device is not sufficiently in compliance with said at least one predetermined policy; and
a connection including a first configuration to connect between said compliance network and said communication device, and a second configuration varying at least partially from said first configuration to connect between said communication device and said destination network.

2. The system of claim 1, wherein said compliance network is also configured to attempt to render said communication device sufficiently in compliance with said at least one predetermined policy, if necessary.

3. The system of claim 1, wherein said compliance network is also configured to provide to said communication device a pass for accessing said destination network if said communication device is determined to be sufficiently in compliance with said at least one predetermined policy.

4. The system of claim 1, wherein said first configuration includes a network device and an authorization, authentication and accounting (AAA) server.

5. The system of claim 4, wherein data is transferred between said communication device and said compliance network in an authentication protocol conversation between said network device and said AAA server.

6. The system of claim 5, wherein said data includes at least one update from said compliance network to said communication device.

7. The system of claim 4 wherein said network device includes an 802.1x switch.

8. The system of claim 1, wherein said first configuration includes a Virtual Private Network (VPN) server.

9. The system of claim 8, wherein data is transferred between said communication device and said compliance network via a virtual private network, said virtual private network including said communication device, a network access server, the Internet, and said VPN server.

10. The system of claim 9, wherein said data includes at least one update from said compliance network to said communication device.

11. A communication device, comprising:
means for selecting a connection between said communication device and a destination network or between said communication device and a compliance network exclusive of said destination network; and
means for establishing said selected connection;
wherein said means for selecting is configured to select said connection with said compliance network exclusive of said destination network when a likelihood that said communication device is not in sufficient compliance with at least one predetermined policy of said destination network exceeds a predetermined level.

12. The communication device of claim 1 1, further comprising:
means for evaluating at least one predetermined condition, wherein said evaluated at least one predetermined condition is used by said means for selecting in selecting said connection for said communication device.

13. The communication device of claim 11, further comprising:
means for receiving updates from said compliance network; and
means for applying said received updates to said communication device.

14. The communication device of claim 11, further comprising:
means for receiving a pass from said compliance network which allows access of said communication device to said destination network, wherein said means for selecting a connection is configured to select a connection with said destination network when said communication device holds a valid pass received by said pass-receiving means.

15. A method of enabling compliance of a communication device with the policies of a destination network, comprising:
operating a communication device intending to connect to a destination network via a connection between said communication device and said destination network, said communication device connecting instead to a compliance network via a connection between said communication device and said compliance network, wherein said connection between said communication device and said destination network is different than said connection between said communication device and said compliance network;
checking, by said compliance network, said communication device for sufficient compliance with at least one predetermined policy of the destination network; and
preventing, if said communication device is not in sufficient compliance with said at least one predetermined policy, said communication device from connecting to said destination network.

16. The method of claim 15, further comprising:
receiving by said communication device, if said communication device is not in sufficient compliance with said at least one predetermined policy, at least one appropriate update from said compliance network, and checking by said compliance network if said communication device is subsequently in sufficient compliance with said at least one predetermined policy.

17. The method of claim 16, further comprising:
disconnecting said communication device from said compliance network and applying said received at least one appropriate update prior to connecting to said destination network.

18. The method of claim 15, further comprising:
connecting, if said compliance network can not render said communication device in sufficient compliance with said at least one predetermined policy, said communication device to a quarantine network.

19. The method of claim 15, further comprising: providing, by said compliance network, said communication device with a pass to connect with said destination system if said compliance network determines that said communication device is in sufficient compliance with all of at least one predetermined policy of said destination network.

20. The method of claim 19, further comprising:
monitoring, during said connection with said destination network, by said communication device of at least one predetermined condition, and attempting if a likelihood that said communication device is not in sufficient compliance with at least one predetermined policy exceeds a predetermined level, to remedy said non-compliance.

21. The method of claim 20, wherein said attempting to remedy includes disconnecting said communication device from said destination network, and checking by said compliance network of said communication device for sufficient compliance and if necessary said communication device being rendered in sufficient compliance prior to being allowed to reconnect to said destination network.

22. The method of claim 15, wherein said stage of said communication device connecting instead to said compliance network occurs when a likelihood that said communication device is not in sufficient compliance exceeds a predetermined level.

23. A method for transferring data between a communication device and a computer network, comprising:
transferring data between the communication device and the computer network within an authentication protocol conversation between an AAA server and client thereof, wherein said data includes data unrelated to said authentication protocol.

24. The method of claim 23, wherein said computer network includes a compliance network and said data includes an update from said compliance network for said communication device.

25. A system for transferring data between a communication device and a computer network, comprising:
a communication device and a computer network; and
an AAA server and a client to said AAA server connected between said communication device and said computer network;
wherein an authentication protocol conversation between said server and said client is used to transfer data between said communication device and said computer network, said data including data unrelated to said authentication protocol.

26. The system of claim 25, wherein said computer network includes a compliance network and said data includes an update from said compliance network for said communication device.
